(19) United States
(12) Patent Application Publication
(10) Pub. No.: US 2014/0157177 A1
(43) Pub. Date: Jun. 5, 2014

(54) CONSOLIDATED DISPLAY OF TIME-BASED EVENTS ASSOCIATED WITH MULTIPLE SYSTEMS

(71) Applicant: NISHANT GHADGE, Ulhasnagar (IN)

(72) Inventor: NISHANT GHADGE, Ulhasnagar (IN)

(21) Appl. No.: 13/689,759

(22) Filed: Nov. 30, 2012

(51) Int. Cl. G06F 3/0481

(52) U.S. Cl. CPC G06F 3/0481
USPC 715/772

(57) ABSTRACT

Various embodiments of systems and methods for rendering calendar events belonging to multiple systems in a single calendar layout are described herein. The method includes receiving a selection of multiple electronic calendars belonging to multiple systems. Further, calendar data related to the selected calendars are consolidated based on a temporal order of occurrence of events. Based on the consolidated calendar data, a graphical representation of the consolidated calendar data is generated. The graphical representation includes a calendar grid showing a listing of the multiple systems along a first axis and a first time frame along a second axis. In response to receiving a selection of a second time frame through a user-selectable time grid, the calendar grid is modified by replacing the first time frame along the second axis with the selected second time frame while keeping the listing of multiple resources along the first axis constant.

### FIELD

This application relates generally to electronic calendars, and more particularly to a technology for displaying calendar events associated with multiple systems in a single calendar layout of a graphical user interface.

### BACKGROUND

Electronic calendars provide a user the ability to input and save numerous calendar entries representing, for example, events, appointments or meetings as well as recurring appointments or meetings. Based on the saved calendar entries, a user can identify those time slots that are available and schedule new appointments or events during the identified time slots. Particularly, businesses that manage resources or provide services to their clients pay close attention to scheduling and resource utilization by monitoring electronic calendars associated with the clients. For example, a business providing information technology (IT) services such as providing critical updates, installing software patches, providing security updates, scheduling downtimes etc., needs to access information regarding the incidents and events occurring at the client side. It is imperative to keep a track of which client has critical need for network resources; knowing which client has peak business hours and non-business hours; notifying a services scheduling staff of upcoming appointments or events at the client side; quickly answering client inquiries regarding resource availability, etc. These tasks are a common challenge to all service-oriented businesses, and a major portion of each work day is spent monitoring client schedules. Often one or 111.0re employees are dedicated to nothing more than monitoring client schedules and ensuring services are with the right client at the right time.

To address this problem, conventionally several solutions and tools have been used to help track calendar entries belonging to multiple clients. Some of the scheduling software applications provide a side by side display of multiple calendars. Some other scheduling software applications provide a calendar showing merged calendar entries belonging to multiple entities. However, the problem remains that the calendar layout provided by these tools do not provide the flexibility for a user to view the calendar entries at varying granular levels while at the same time maintaining the visibility of the calendar entries (pertaining to multiple systems) to be from a single point of view.

### SUMMARY

Various embodiments of systems and methods displaying calendar events associated with multiple systems in a single calendar layout of a graphical user interface are described herein. In an aspect, the method involves receiving a selection of multiple electronic calendars, the multiple electronic calendars belonging to multiple resources. The method further includes accessing calendar data related to the selected calendars, where the calendar data includes one or more events associated with one or more instances of time. The calendar data is then consolidated based on a temporal order of occurrence of events. In an aspect, a graphical representation of the consolidated calendar data is generated, in which the graphical representation includes a calendar grid showing a listing of the multiple resources along a first axis, a first time frame along a second axis, and data objects indicating the occurrence of events correlated to a resource on the first axis and an instance of time on the second axis. In another aspect, in response to receiving a selection of a second time frame through a user-selectable time grid, the calendar grid is modified by replacing the first time frame along the second axis with the selected second time frame while keeping the listing of multiple resources along the first axis constant. Further, the method includes resizing the calendar grid according to the second time frame.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates a conceptual diagram of the technology for displaying calendar events associated with multiple systems in a single display layout of a graphical user interface, according to one embodiment.

FIG. 2 is a flow diagram of a method for displaying calendar events associated with multiple systems in a single display layout of a graphical user interface, according to one embodiment,

FIG. 3 is a flow diagram of a method for displaying calendar events associated with multiple systems in a single display layout of a graphical user interface, according to another embodiment.

FIG. 4 is a block diagram of an exemplary system for generating a common calendar layout, according to one embodiment

FIG. 5 illustrates an exemplary graphical user interface showing a calendar layout, in accordance with an embodiment.

FIG. 6 illustrates an exemplary graphical user interface showing a calendar layout, in accordance with another embodiment.

FIG. 7 illustrates an exemplary graphical user interface showing a calendar layout, in accordance with another embodiment.

FIG. 8 illustrates an exemplary graphical user interface showing a calendar layout, in accordance with another embodiment.

FIG. 9 is a block diagram of an exemplary computer system according to one embodiment.

### DETAILED DESCRIPTION

Embodiments of techniques for displaying calendar events associated with multiple systems in a single calendar layout of a graphical user interface are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Electronic calendars, that is, calendars maintained on an electronic device such as a computer, provide a user the ability to input and save numerous calendar entries representing, for example, events, appointments or meetings as well as recurring appointments or meetings. Various functional systems within a business may capture time based planned events using such electronic calendars. Examples of functional systems include Production, Sales, Human Resources (HR), Finance, Payroll, Administration, Warehouse, Store, Research and Development (R&D), and the like. Whereas, service providing systems, such as an information technology (IT) service providing system within the same business may access the electronic calendars to acquire a collective knowledge of the planned events associated with the various systems. In an embodiment the planned events captured in the electronic calendars associated with the various systems are consolidated and displayed in a single calendar layout on a graphical user interface (GUI).

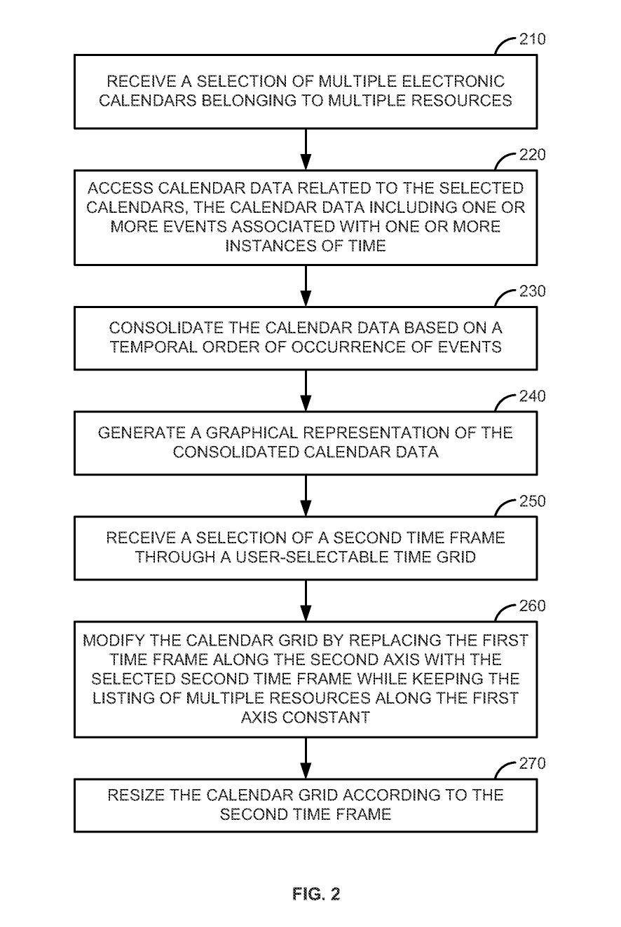

In an example scenario, an IT team of an organization provides various IT related services such as managing system downtimes, plan new downtimes, implement new downtimes, manage resources, perform software maintenance, perform software and/or system upgrades, send software patches, send notifications, trouble shoot software and hardware issues, etc. In order to efficiently provide such services, the IT team requires information, regarding the various functional systems, such as impact (of resources/systems on business processes, solutions, and products), dependency, scheduled calendar events, work-modes, etc. The IT team gathers some of the required information from time-based events captured in the respective electronic calendars of systems. In order to have visibility of time-based events pertaining to all system from a single point of view, the IT team accesses a consolidated calendar layout. By looking-up the consolidated calendar layout, the IT personnel may schedule certain services according to the schedule of the respective systems. The consolidated calendar layout is generated as described with reference to FIGS. 2-7.

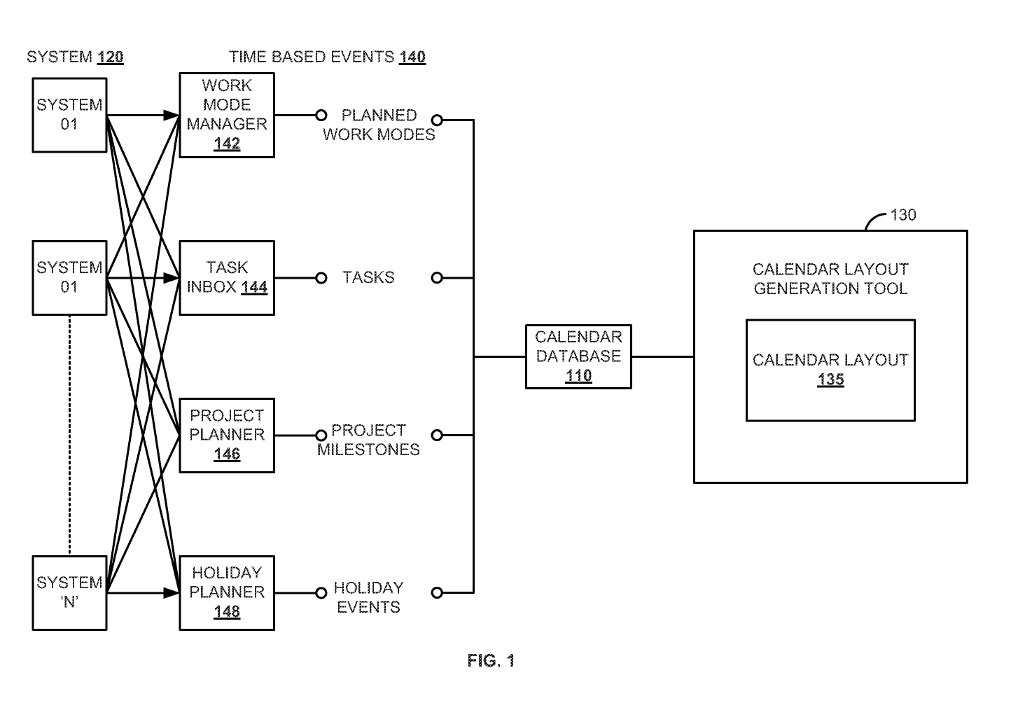

According to the concept described with reference to FIG. 1, a calendar database 110 is communicatively coupled to multiple systems 120 and a calendar layout generation tool 130. The calendar layout generation tool 130 extracts time-based events 140 associated with each of the multiple systems 120 and stores the extracted information in the calendar database 110. In an example, time-based events such as planned work modes, tasks, project milestones, and holiday events are extracted from a work mode manager 142, task inbox 144, project planner 146, and holiday calendar 148 of the multiple systems, respectively. The calendar layout generation tool 130 then generates a single calendar layout 135 displaying a consolidated view of the time-based events across the multiple systems. The single calendar layout 135 is configured in such a way that the time frame for displaying the scheduled events can be varied without effecting a change in the original calendar layout, as will be described in more detail with reference to FIG. 2. The generated single calendar layout 135 is an active interface, in that, a user can input calendar entries representing newly scheduled events in real-time. The generated single calendar layout 135 updated with the newly scheduled events may be sent to the multiple systems 120 in order to notify the users of multiple systems of the newly scheduled events.

FIG. 2 illustrates a flow diagram of a method 200 for displaying calendar events associated with multiple systems in a single calendar layout of a graphical user interface. The method implemented by a computer or any other electronic device having processing capabilities, includes at least the following process illustrated with reference to process blocks 210 to 270. The process of displaying calendar events associated with multiple systems in a single calendar layout involves receiving a selection of multiple electronic calendars belonging to multiple resources, at process block 210. The term “resources” as used herein refers to persons, systems, domains, or entities to which one or more time-based events can be associated with. Further, at process block 220, the calendar data related to the selected calendars are accessed. Examples of calendar data include planned meetings, appointments, events, trainings, seminars, workshops, work-mode, holiday, presentations, etc.

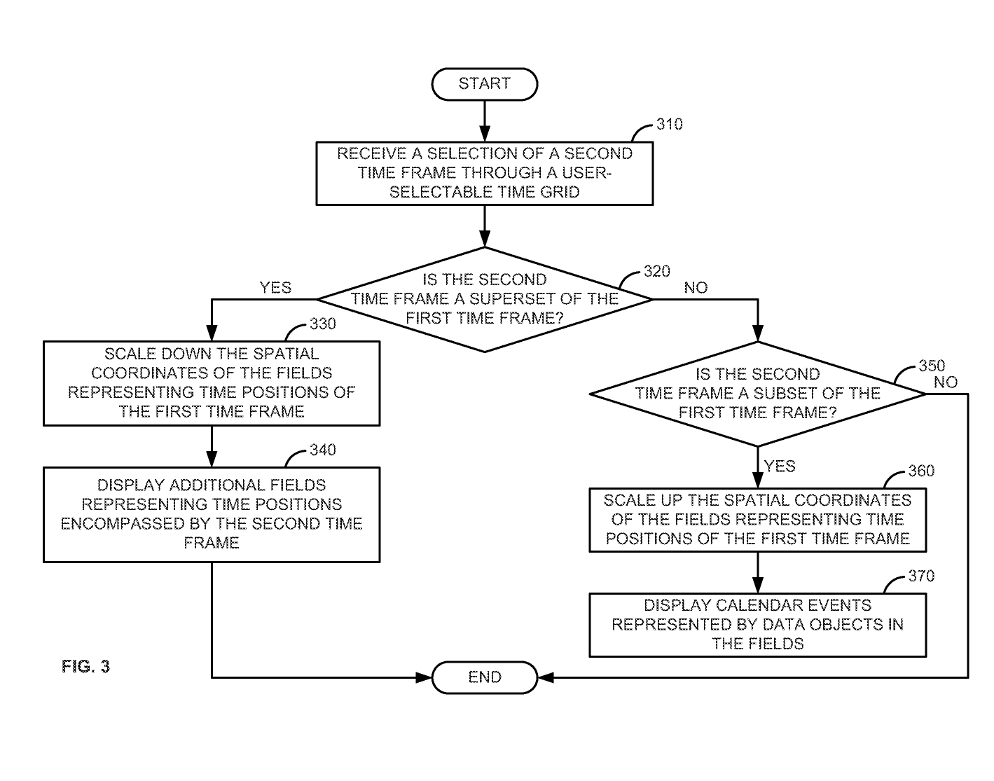

At process block 230, the calendar data relating to the selected multiple calendars are consolidated. In an aspect, the calendar data relating to the selected multiple calendars are consolidated based on a temporal order of occurrence of events. At process block 240, a graphical representation of the consolidated data is generated. In an aspect, the graphical representation includes a calendar grid showing a listing of the multiple resources along a first axis, a first time frame along a second axis, and data objects indicating the occurrence of events correlated to a resource on the first axis and an instance of time on the second axis. In an example, the first axis represents the y-axis of a Cartesian co-ordinate system and the second axis represents the x-axis of the Cartesian co-ordinate system. Further, at process block 250, a selection of a second time frame is received via a user-selectable time grid. The term “user-selectable time grid” as used herein refers to a set of tabs, each representing a time-frame selectable via the graphical user interface. In response to receiving a selection of a second time frame, at process block 260, the calendar grid is modified by replacing the first time frame along the second axis with the selected second time frame while at the same time, keeping the listing of the multiple resources along the first axis constant. At process, block 270, the calendar grid is resized according to the second time frame. In an embodiment, the method includes receiving a selection of a data object and displaying event information associated with the selected data object. In another embodiment, the method includes receiving a selection of a particular type of calendar events and displaying data objects representing the particular type of calendar events occurring within the selected time frame. The process of modifying the calendar grid in response to receiving a selection of the second time frame is described in more detail with reference to FIG. 3.

Referring to FIG. 3, at process block 310, a selection of the second time frame is received via the user-selectable time grid. In response to receiving the selection, at decision block 320, it is determined whether the second time frame is a superset of the first time frame. The term “superset” as used herein refers to a data range that encompasses another datum or data range. In an example, a time frame such as “month” is considered a superset of time frames such as “week” arid “day.” If it is determined that the second time frame is a superset of the first time frame, then the spatial coordinates of the fields, representing time positions, in the calendar grid are scaled down, at process block 330. The term “scale down” as used herein refers to the act of proportionally reducing or minimizing a quantifiable property of an element, in this case, the spatial coordinates. Scaling down the spatial coordinates makes space for displaying additional time positions encompassed by the second time frame, at process block 340. However, scaling down the spatial coordinates of the fields representing time positions does not effect a subsequent change in the spatial positions of the fields representing the multiple resources along the first axis. In other words, the fields representing the multiple resources are kept unchanged throughout the calendar grid modification process. In an example, if the selected second time frame is “month” while the first time frame is “second week” then the spatial coordinates of the fields, representing time positions within the “second week,” are reduced in order to accommodate additional fields for time positions occurring within the first, third, fourth, and fifth week (if any) of the “month” time frame. In an aspect, the spatial coordinates are reduced as a function of the dimensions of the calendar grid and an estimate of additional time positions encompassed by the second time frame.

Alternatively, at process block 320 if it is determined that the second time frame is not a superset of the first time frame, then the process proceeds to decision block 350. At decision block 330, it is determined whether the second time frame is a subset of the first time frame. The term “subset” as used herein refers to a range of data whose members are members of another range. In an example, a time frame such as “month” is considered a subset of time frame “year” and “quarter.” If it is determined that the second time frame is a subset of the first time frame, then the spatial coordinates of the fields, representing time positions of the first time frame are scaled up, at process block 360. The term “scale up” as used herein refers to the act of proportionally increasing or maximizing a quantifiable property of an element, in this case the spatial coordinates of the fields. Scaling up the spatial coordinates of the fields creates space for displaying the calendar events represented by the data objects in the corresponding fields, at process block 370. However, scaling up the spatial coordinates of the fields representing time positions does not effect a subsequent change in the spatial positions of the fields representing the multiple resources along the first axis. In an example, when the calendar grid is rendered according to a first time frame “year” and the selected second time frame is “month,” then the spatial coordinates of the fields, representing time positions of the selected “month” within the first time frame “year,” are increased while the fields representing time positions for the other months in the “year” time frame are removed. The fields representing the time positions are scaled up in order to provide an expanded view of the calendar events (if any) rendered within the fields.

Alternatively, if it is determined that the second time frame is not a subset of the first time frame, then the calendar grid remains unchanged.

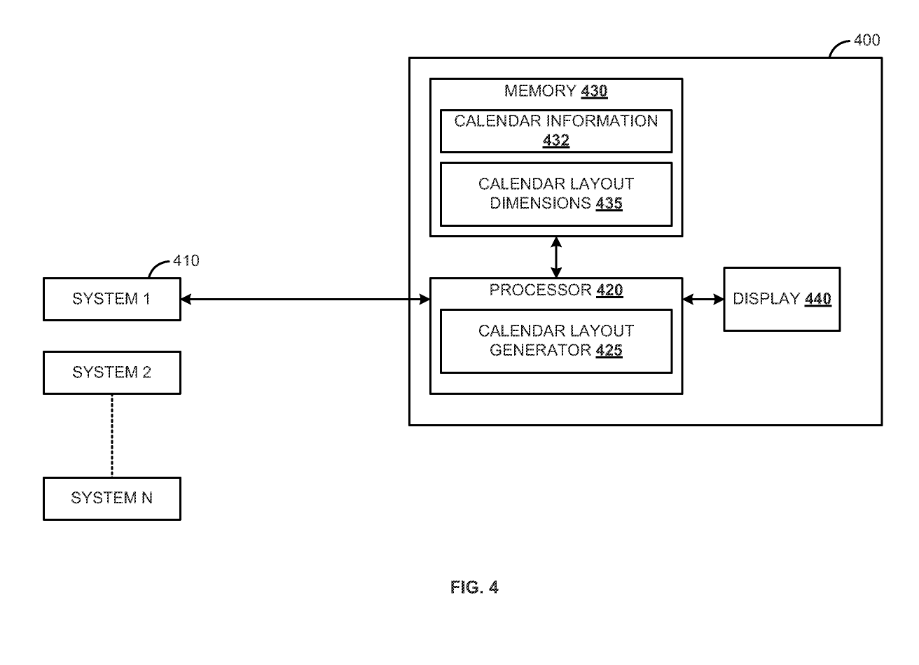

FIG. 4 is a block diagram of an exemplary system 400 for automatically generating an optimized layout plan using a layout optimization tool, according to one embodiment. The system 400 may be communicatively coupled to multiple functional systems 410. The multiple functional systems 410 refer to systems pertaining to various functional areas of an organization such as finance, production, HR, R&D, marketing, sales, etc. In an aspect, one or more of the functional systems 410 may also serve as sources of data that enable data storage and/or retrieval. Examples include databases, web applications, web server, a reporting tool, data server etc. Examples of databases include relational, transactional, hierarchical, multi-dimensional (e.g., OLAP), object oriented databases, and the like.

In an embodiment, the system 400 includes a processor 420 that executes software instructions or code comprising the layout optimization tool, stored on a computer readable storage medium, to perform the above-illustrated methods. The system 400 includes a media reader to read the instructions from the computer readable storage medium and store the instructions in storage or in random access memory (RAM). For example, the computer readable storage medium includes executable instructions for performing operations including, but not limited to, invoking calendar information relating to multiple systems 410 associated with the system 400, generating an optimized calendar layout for displaying consolidated calendar information belonging to the multiple systems 410, and configuring the calendar layout to display calendar entries from a single point of view, without affecting the orientation of the listing of multiple systems across changing time frames. In an aspect, the system 400 is an IT system and the multiple systems 410 are client systems associated with the IT system. Examples of client systems include Production, Sales, Human Resources (HR), Finance, Payroll, Administration, Warehouse, Store, Research and Development (R&D), and the like.

According to an aspect, the memory 430 holds the calendar information 432 pertaining to the multiple systems 410. The calendar information 432 includes scheduled tasks, critical uptimes, downtimes, appointments, projects, and any other time-based events.

The processor 420 may retrieve the calendar information 432 directly from the various systems 410 or from the memory 430. The processor 420 then processes the calendar information 432 using the calendar layout generator 425. In an embodiment, the processor 420 generates a consolidated calendar layout according to pre-defined layout dimensions and pre-defined orientation of certain elements of the calendar. In an aspect, the generated calendar layout includes a calendar grid composed of a list of system identifiers, a set of instances of time (days, weeks, months, etc.) of a particular time frame (week, month, year etc.), and fields for marking the time positions corresponding to each instance of time. In an aspect, some of the fields marking the time positions hold one or more data objects. The data objects indicate the occurrence of time-based events for a particular system at a particular instance of time. In an aspect, the data objects are rendered as graphical representations of time-based events, such as symbols, color coded shapes, text, string of characters, patterns, etc. In an aspect, the system identifier is an identification number, name, or a combination that identifies a respective system. The generated calendar layout is rendered along with a user-selectable time grid on the GUI. When a selection of a second time frame is received via the user-selectable time grid, the processor modifies the calendar grid as a function of the second time frame and the calendar layout dimensions 435 stored in memory 430. In an aspect, the calendar grid is modified by scaling the dimensions of the fields (marking time positions) according to the amount of space required in the calendar layout for rendering the fields that mark the time instances of the second time frame.

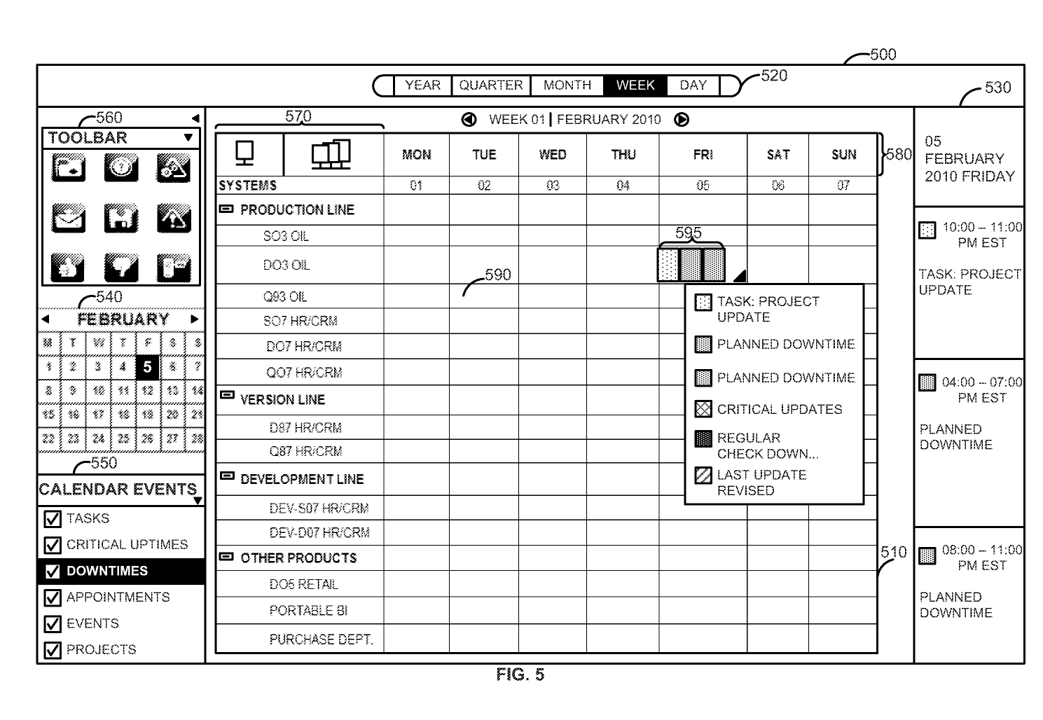

FIG. 5 shows a graphical representation of a calendar layout 500 according to some embodiments. The calendar layout 500 includes a calendar grid 510, a user-selectable time grid 520, a task pane 530, a calendar 540, an events grid 550, and a toolbar 560. The calendar grid 510 includes fields 570 along a first axis representing multiple systems and fields 580 along a second axis representing a time frame. The calendar grid further includes fields 590 representing time positions mapped to the multiple resources. The fields 590 representing time positions may also hold data objects 595 representing events occurring within an associated time position.

The events grid 550 provides options for a user to select one or more specific type of calendar events for viewing on the calendar grid. In the given example, the options include Tasks, Critical Uptimes, Downtimes, Appointments, Events, Projects etc., are provided in the collapsible events grid. Upon receiving a selection of one or more event types from the events grid 550, the calendar grid 510 is configured to display only events pertaining to the selected event types, in the respective fields 590 of time positions.

The calendar 540 provides an interface for a user to quickly select a particular instance of time such as a day of a month, a month of a year, etc., for viewing. In the given example, the calendar grid 510 provides a listing of systems in the first column 570 and instances (days) of the time frame “week” in the first row 580. The fields 590 representing time positions may hold a data object 595 if an event occurs at a corresponding instance of time for a corresponding system. When a particular date is selected via the calendar 540, the calendar grid 510 shifts the focus of the viewing frame to the selected date. This enables a user to avoid scrolling through the calendar grid in order to view the events occurring on a particular “day.” Similarly, when the rendered time frame is “year,” the calendar provides options for selecting a particular month of the year, in order to instantly shift the focus of the viewing frame to the selected “month.” Upon receiving a selection of an instance of time through the calendar 540, the fields 590 representing the corresponding time positions are brought into focus. For example, when the month being rendered is “February,” and a user wants to view the calendar events occurring within the month of “October.” then the user needs to simply select “Oct” from the calendar 540, instead of scrolling through the calendar grid 510 to the particular month.

The optional toolbar 560 provides quick access to additional features such as Folders, Help, Settings, Save, Email, etc.

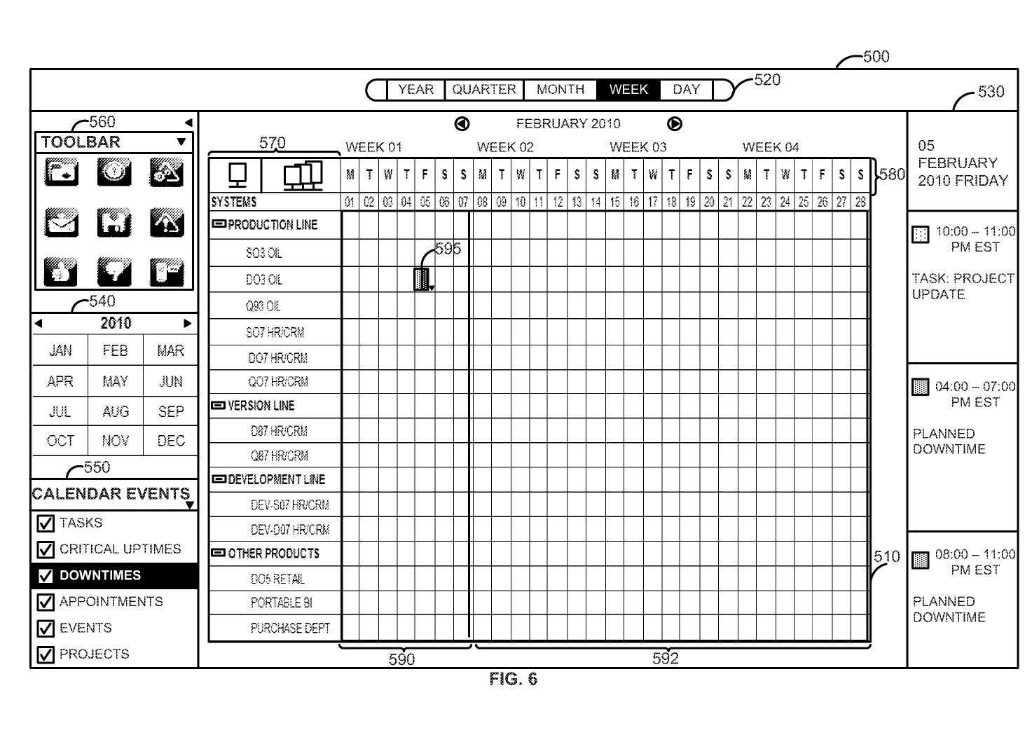

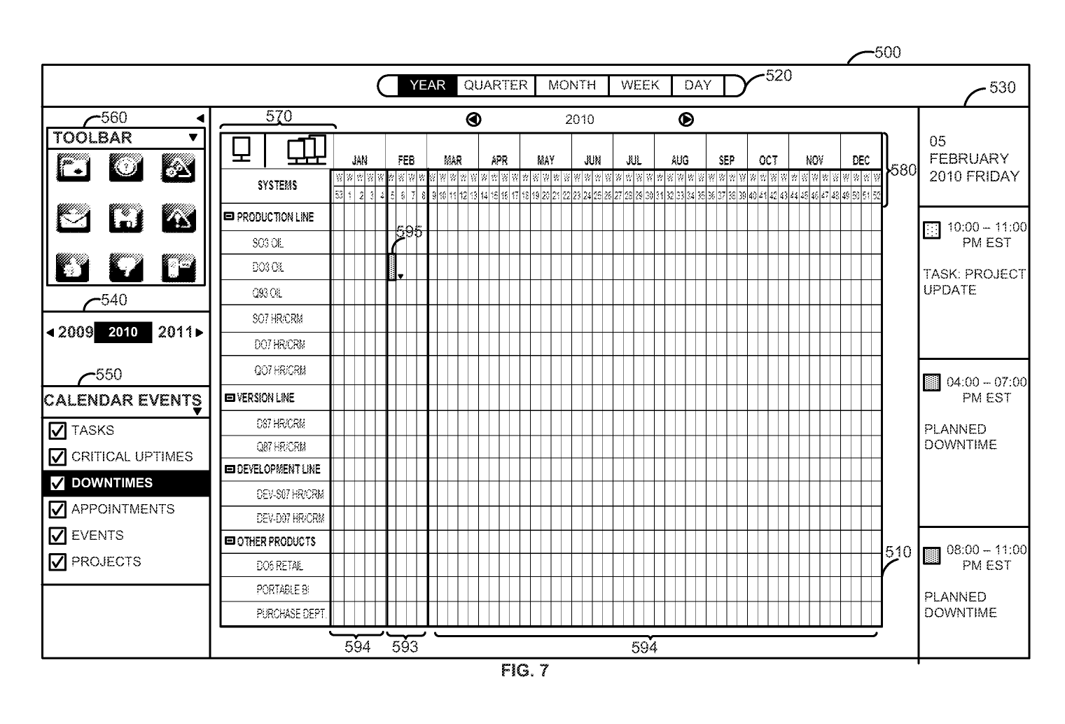

The user-selectable time grid 520 includes a set of tabs each representing a corresponding range of time. In the given example, the time grid 520 provides tabs for selecting a time frame such as year, quarter, month, week, and day, such that selecting a particular time frame displays the corresponding time positions along the first row 580 of the calendar grid 510. However, the multiple systems listed along the first column 570 remain unchanged irrespective of the time frame being selected. For example, referring to FIGS. 5-8, when a particular time frame is selected from the time grid 520, the calendar grid 510 is modified to include or exclude certain time positions according to the selected time frame. FIG. 5 shows a calendar grid 510 rendered according to a “week 1” time frame. Subsequently, when another time frame such as “month” is selected from the time grid 520, then the calendar layout 500 is modified as shown in FIG. 6, where the fields 590 representing time positions for “week 1” as previously displayed are shrunk and additional fields 592 representing time positions for “week 2,” “week 3,” “week 4,” and “week 5” are displayed. However, the fields 570 holding the listing of the multiple systems along the first column remain unaffected. Similarly, when another time frame such as “year” is selected from the time grid 520, then the calendar layout 500 is modified as shown in FIG. 7, where the fields 539 representing time positions for “February” as previously displayed are shrunk and additional fields 594 representing time positions for other months of the year are displayed. However, the fields 570 holding the listing of the multiple systems along the first column remain unaffected.

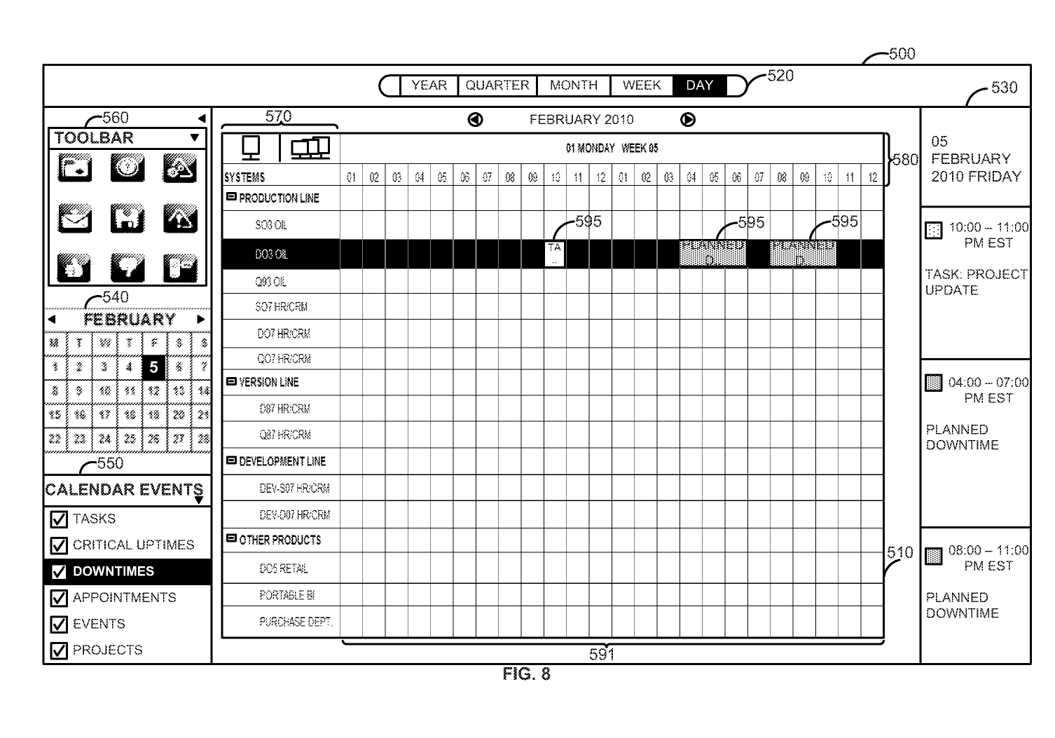

In another example shown in FIG. 8, when a time frame such as “day” of a month February is selected from the time grid 520, then the calendar layout 500 is modified in such a way that the fields 594 representing time positions for other months of a “year” as previously displayed are removed and only the fields 591 representing time positions for the selected day e.g., February 1^{st} is displayed. However, the fields 570 holding the listing of the multiple systems along the first column remain unaffected. Also, as shown in FIG. 8, the fields 591 representing time positions are rendered in an expanded state to display the content represented by the data object 595, in this case “Task” at time position 10:00 hours and “planned downtime” at 16:00 to 18:00 hours and 20:00 to 22:00 hours corresponding to system “D03 OIL” of “Production Line.”

Some embodiments may include the above-described methods being written as one or more software components. These components, and the functionality associated with each, may he used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or sonic other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

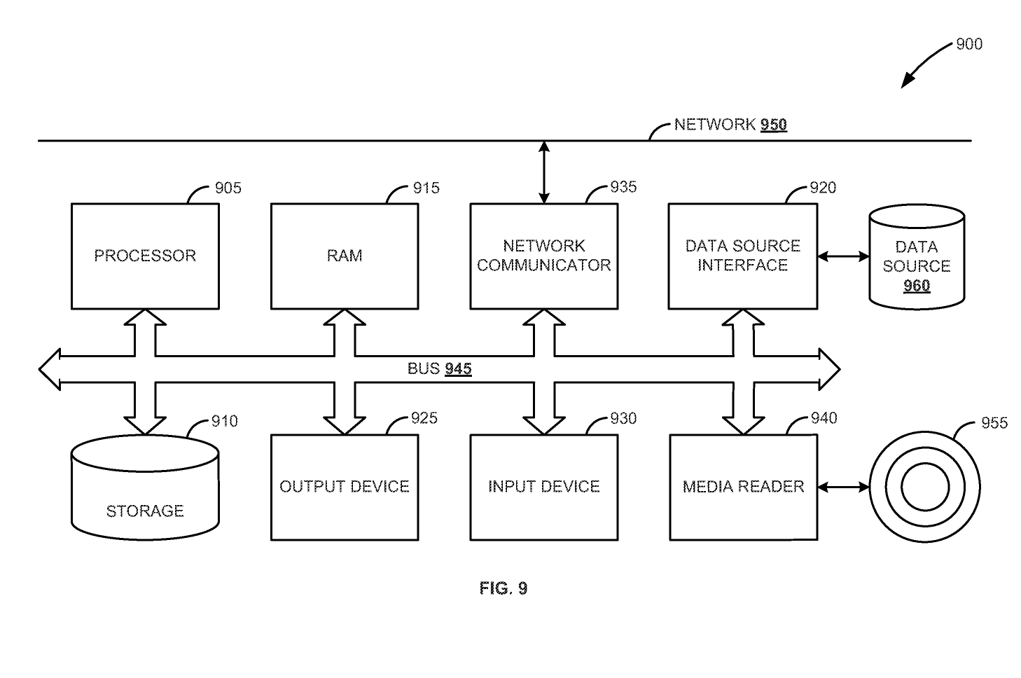

FIG. 9 is a block diagram of an exemplary computer system 900. The computer system 900 includes a processor 905 that executes software instructions or code stored on a computer readable storage medium 955 to perform the above-illustrated methods. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users arid an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data hat enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method of displaying multiple electronic calendars, the method comprising:
receiving a selection of multiple electronic calendars,wherein the multiple electronic calendars belong to multiple resources;
accessing calendar data related to the selected calendars, wherein the calendar data includes one or more events associated with one or more instances of time;
consolidating the calendar data based on a temporal order of occurrence of events;
generating a graphical representation of the consolidated calendar data, wherein the graphical representation includes a calendar grid displaying a listing of the multiple resources along a first axis, a first time frame along a second axis, and data objects indicating the occurrence of events correlated to a resource on the first axis and an instance of time on the second axis;
receiving a selection of a second time frame through a user-selectable time grid;
modifying the calendar grid by replacing the first time frame along the second axis with the selected second time frame while maintaining the listing of multiple resources along the first axis; and
resizing the calendar grid according to the second time frame.

2. The method of claim 1, wherein the listing of the multiple resources, the first time frame, and the data objects are rendered within a first set of fields in the calendar grid, wherein the first set of fields represent corresponding time positions in the first time frame.

3. The method of claim 2, wherein resizing the calendar grid comprises:
calculating an amount of space required in the calendar grad for rendering a second set of fields representing time positions of the second time frame; and
adapting the spatial co-ordinates associated with the first set of fields according to the calculated amount of space.

4. The method of claim 3, wherein calculating an amount of space required in the calendar grid comprises:
determining whether the second time frame is a superset of the first time frame; and
upon determining that the second time frame is a superset of the first time frame, scaling down the spatial coordinates of the first set of fields to accommodate the second set of fields within the calendar grid.

5. The method of claim 3, wherein calculating an amount of space required in the calendar grid comprises:
determining whether the second time frame is a subset of the first time frame; and
upon determining that the second time frame is a subset of the first time frame, scaling up the spatial coordinates of the first set of fields to display the events represented by the data objects in one or more of the first set of fields.

6. The method of claim 1, further comprising displaying event information associated with a calendar event in response to receiving a selection of a data object representing the calendar event.

7. The method of claim 1 further comprising:
receiving a selection of a particular type of calendar events; and
displaying data objects representing the particular type of calendar events occurring with in a selected time frame.

8. An article of manufacture, comprising:
a computer readable storage medium having instructions which when executed by a computer causes the computer to:
receive a selection of multiple electronic calendars, wherein the multiple electronic calendars belong to multiple resources;
access calendar data related to the selected calendars, wherein the calendar data includes one or more events associated with one or more instances of time;
consolidate the calendar data based on a temporal order of occurrence of events;
generate a graphical representation of the consolidated calendar data, wherein the graphical representation includes a calendar grid showing a listing of the multiple resources along a first axis, a first time frame along a second axis, and calendar events correlated to a resource on the first axis and an instance of time on the second axis;
receive a selection of a second time frame through a user-selectable time grid;
modify the calendar grid by replacing the first time frame along the second axis with the selected second time frame while keeping the orientation of the listing of multiple resources along the first axis constant; and
resize the calendar grid according to the second time frame.

9. The article of manufacture in claim 8, wherein the computer readable storage medium further comprises instructions, which when executed by the computer causes the computer to:
receive a selection of a particular type of calendar events; and
display data objects representing the particular type of calendar events occurring within a selected time frame,

10. The article of manufacture in claim 8, wherein the calendar events are rendered within a first set of fields in the calendar grid, wherein the first set of fields represent corresponding time positions of the first time frame.

11. The article of manufacture in claim 10, wherein resizing the calendar grid comprises:
calculating an amount of space required in the calendar grid for rendering a second set of fields representing time positions of the second time frame; and
adapting the spatial co-ordinates associated with the first set of fields according to the calculated amount of space.

12. The article of manufacture in claim 11, wherein calculating an amount of space required in the calendar grid comprises:
determining whether the second time frame is a superset of the first time frame;
and
upon determining that the second time frame is a superset of the first time frame, scaling down the spatial coordinates of the first set of fields to accommodate the second set of fields within the calendar grid.

13. The article of manufacture in claim 11, wherein calculating an amount of space required in the calendar grid comprises:
determining whether the second time frame is a subset of the first time frame; and
upon determining that the second time frame is a subset of the first time frame, scaling up the spatial coordinates of the first set of fields to display information pertaining to the calendar events rendered in one or more of the first set of fields.

14. A computer-implemented method of displaying multiple electronic calendars, the method comprising:
receiving a selection of multiple electronic calendars, wherein the multiple electronic calendars belong to multiple resources;
accessing calendar data related to the selected calendars, wherein the calendar data includes one or more events associated with one or more instances of time;
consolidating the calendar data based on a temporal order of occurrence of events;
generating a graphical representation of the consolidated calendar data, wherein the graphical representation includes a calendar grid showing a listing of the multiple resources along a first axis, a first time frame along a second axis, undo first set of fields holding calendar events corresponding to a resource on the first axis and an instance of time on the second axis;
receiving a selection of a second time frame through a user-selectable time grid;
replacing the first time frame along the second axis with the selected second time frame while keeping the orientation of the listing of multiple resources along the first axis constant;
calculating an amount of space required in the calendar grid for displaying a second set of fields representing time positions of the second time frame;
adapting the spatial co-ordinates associated with the first set of fields according to the calculated amount of space; and
rendering the calendar grid showing calendar events occurring within the second time frame.

15. A system operating in a communication network, comprising
one or more data source systems; and
a computer comprising a memory to store a program code, and a processor to execute the program code to:
receive a selection of multiple electronic calendars, wherein the multiple electronic calendars belong to multiple resources;
access calendar data related to the selected calendars from the one or more data source systems, wherein the calendar data includes one or more events associated with one or more instances of time;
consolidate the calendar data based on a temporal order of occurrence of events;
generate a graphical representation of the consolidated calendar data, wherein the graphical representation includes a calendar grid showing a listing of the multiple resources along a first axis, a first time frame along a second axis, and calendar events correlated to a resource on the first axis and an instance of time on the second axis;
receive a selection of a second time frame through a user-selectable time grid;
modify the calendar grid by replacing the first time frame along the second axis with the selected second time frame while maintaining the orientation of the listing of multiple resources along the first axis constant; and
resize the calendar grid according to the second time frame.

16. The system of claim 15, wherein the calendar events are rendered in one or more of a first set of fields of the calendar grid, wherein the first set of fields represent corresponding time positions of the first time frame.

17. The system of claim 15, wherein the first time frame and the second time frame are one of a year, quarter, month, week, or day.

18. The system of claim 15, wherein the multiple resources include at least one of systems, persons, domains, or any other entities.

19. The system of claim 15, wherein the calendar grid is a tabular representation having the multiple resources rendered within fields forming a first column of a table and the first time frame rendered within fields forming a first row of the table.

20. The system of claim 15, wherein the system is an Enterprise Resource Planning (ERP) system having one or more business modules integrated over the communication network.
